(19) United States
(12) Patent Application Publication
(10) Pub. No.: US 2021/0388948 A1
(43) Pub. Date: Dec. 16, 2021

(54) TANK HOLDER

(71) Applicant: TOYOTA JIDOSHA KABUSHIKI KAISHA, Toyota-shi (JP)

(72) Inventor: Manabu FUJII, Toyota-shi (JP)

(21) Appl. No.: 17/221,923

(22) Filed: Apr. 5, 2021

(30) Foreign Application Priority Data
Jun. 10, 2020 (JP) 2020-100727

(51) Int. Cl. F17C 13/08

(52) U.S. Cl. CPC F17C 13/084; F17C 2205/0103; F17C 2270/0184; F17C 2201/0109; F17C 2221/012; F17C 2203/0619; F17C 2203/0604

(57) ABSTRACT

Provided is a tank holder capable of suppressing a necessary dedicated space. A tank holder to hold a tank includes: a belt-shaped band that is arranged along an outer circumference of the tank, the band being provided with a plurality of pressing elements that protrude to press a surface of the tank and elastically deform.

### FIELD

The present disclosure relates to a holder to fix a tank to equipment of a vehicle etc.

### BACKGROUND

As a means of holding a tank to fix the tank to equipment of a vehicle etc., Patent Literatures 1 to 3 disclose that a rigid frame (support member) having a three-dimensional cross section is placed on one side of a tank along an outer circumference of the tank so that the tank is along the frame, and a metal band that is almost a flat plate (has low rigidity) is arranged on the other side: one end thereof is fixed to the rigid frame and the other end is pressed by a coil spring, so that tension is given to hold the tank.

### CITATION LIST

### Patent Literature

Patent Literature 1: JP 2016-070467 A
Patent Literature 2: JP 2019-074189 A
Patent Literature 3: JP 2016-070468 A

### SUMMARY

### Technical Problem

In the prior art, it is necessary to arrange a coil spring at a portion adjacent to a tank in order to give a metal band tension as described above, which requires a dedicated space. When a plurality of tanks are aligned and installed in equipment, it is necessary to secure the distances between the tanks in view of securing a dedicated portion for coil springs since a coil spring is necessary for each tank. The larger the number of the installed tanks is, the more pronounced a space for the distances is. Some space may be wasted because any point of contact between a tank and a rigid frame rising due to a deviation of the tank in diameter, expansion due to filling-up, etc., may cause the position of the uppermost circumference of the tank to rise beyond the enlargement of the diameter of the tank, which has to be considered in advance to secure a space.

The present disclosure was made with these actual circumstances in view, and a major object thereof is to provide a tank holder capable of reducing a necessary space.

### Solution to Problem

The present application discloses a tank holder to hold a tank, the tank holder comprising: a belt-shaped band that is arranged along an outer circumference of the tank, the band being provided with a plurality of pressing elements that protrude to press a surface of the tank and elastically deform.

The number of the bands may be two, the outer circumference of the tank may be sandwiched between the two bands, and end portions of the two bands may be coupled to each other.

A stiffener plate may be arranged at each of the end portions of the bands, and a long hole extending in a length direction of the bands may be provided with the stiffener plate.

The pressing elements may be like boards and may be coupled to the bands via both ends thereof.

One end of each of the pressing elements may be a free end.

The pressing elements may be coated with a cover.

### Advantageous Effects

The present disclosure is capable of reducing a dedicated space without any coil spring arranged at least as in the conventional.

### BRIEF DESCRIPTION OF DRAWINGS

FIG. 1 is a plan view of a tank 1 where tank holders 10 are arranged;

FIG. 2 is a cross-sectional view taken along the arrows A-A in FIG. 1;

FIG. 3 is a side view of the tank 1 where the tank holders 10 are arranged;

FIG. 4 is a cross-sectional view taken along the arrows B-B in FIG. 1;

FIG. 5 is an enlarged view of the portion indicated by C in FIG. 1;

FIG. 6 is an enlarged view of the portion indicated by D in FIG. 3;

FIG. 7 is an exploded perspective view focused on the portions of stiffener plates 12 and 22;

FIG. 8 is an exploded perspective view focused on the portions of the stiffener plates 12 and 22 of another example;

FIG. 9 is an exploded perspective view focused on the portions of the stiffener plates 12 and 22 of still another example;

FIG. 10 schematically shows FIG. 9 viewed in the direction of the arrow E;

FIG. 11 is an enlarged view of the portion indicated by F in FIG. 1;

FIG. 12 shows a cross section taken along the line G-G in FIG. 11;

FIG. 13 is a perspective view partially showing a band 13;

FIG. 14 illustratively shows another example of the band 13;

FIG. 15 illustratively shows still another example of the band 13;

FIG. 16 illustratively shows a band 53;

FIG. 17 shows a cross section taken along the line H-H in FIG. 16;

FIG. 18 illustratively shows a band 63;

FIG. 19 shows a cross section taken along the line I-I in FIG. 18;

FIG. 20 shows a cross section taken along the line J-J in FIG. 18;

FIG. 21 illustratively shows a band 73;

FIG. 22 shows a cross section taken along the line K-K in FIG. 21;

FIG. 23 shows a cross section taken along the line L-L in FIG. 21;

FIG. 24 illustratively shows a cover 80;

FIG. 25 shows a scene where the tank 1 where the tank holders 10 are arranged is fixed to equipment;

FIG. 26 is an enlarged view of the portion indicated by M in FIG. 25;

FIG. 27 illustratively shows the operation according to difference of the tank in diameter;

FIG. 28 illustratively shows the operation according to difference of the tank in diameter;

FIG. 29 is an enlarged view of the portion indicated by N in FIG. 27; and

FIG. 30 is an enlarged view of the portion indicated by P in FIG. 28.

### DESCRIPTION OF EMBODIMENTS

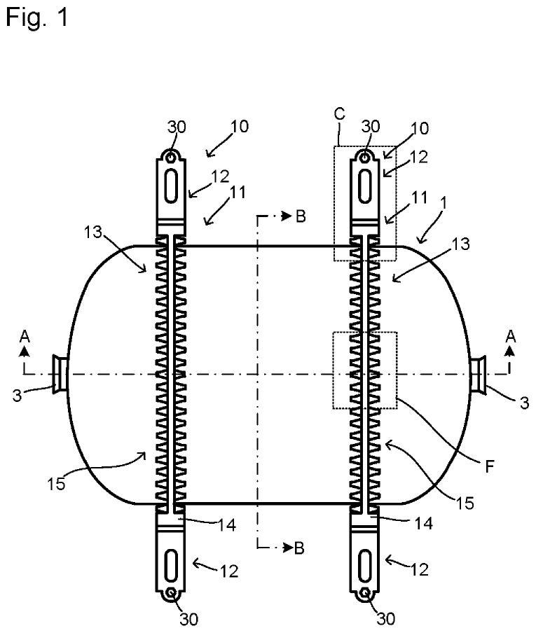

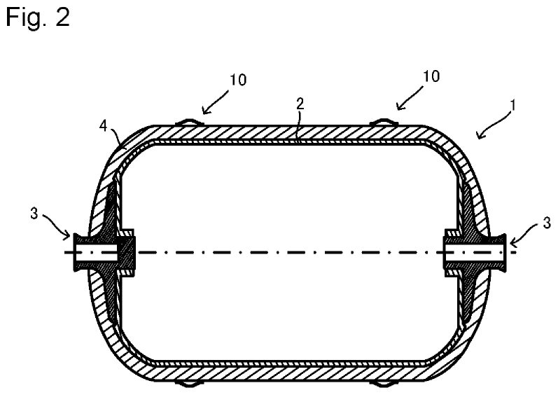

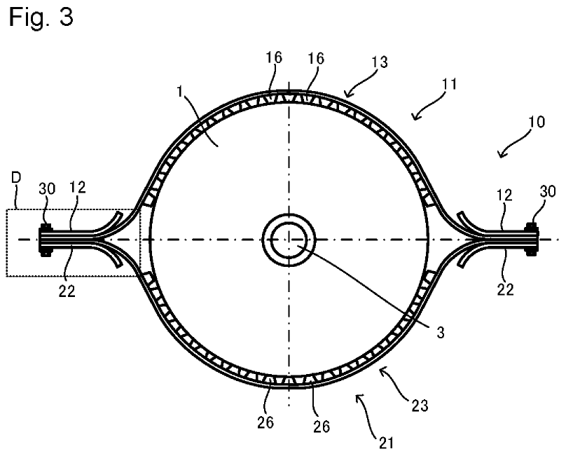

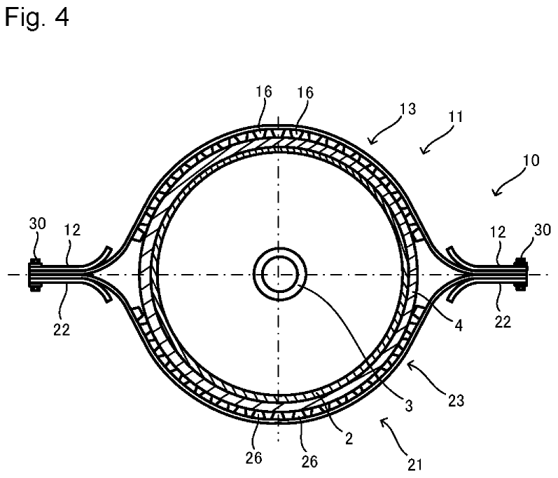

FIGS. 1 to 4 illustratively show a state where a tank 1 is arranged in tank holders 10 according to one example. FIG. 1 is a plan view of the tank 1 and the tank holders 10 (downward view), FIG. 2 is a cross-sectional view taken along the arrows A-A in FIG. 1, FIG. 3 is a right side view of the tank 1 and the tank holders 10 (leftward view of FIG. 1), and FIG. 4 is a cross-sectional view taken along the arrows B-B in FIG. 1.

As can be seen from these figures, the two tank holders 10 hold the tank 1 in this embodiment. The number of the tank holders 10 used for one tank is not limited to two, and may be determined as necessary.

1. Structure of Tank

FIGS. 1 to 4 show the shape of the held tank 1 according to one example. In this example, description will be given as using a tank to store hydrogen that is a fuel for fuel cell vehicles as an example. The tank 1 may be referred to as a high-pressure tank since the pressure thereinside becomes high. The tank 1 in this example has a liner 2, mouthpieces 3 and a stiffener layer 4. The structure of each of the foregoing will be described below.

<Liner>

The liner 2 is a hollow member that defines the space inside the tank 1. The liner 2 is a tubular member, and holds anything housed in the space thereinside (hydrogen in this example) without any leakage. More specifically, the diameter of the liner 2 is shortened at both axial ends of the tube, and the mouthpieces 3 are fitted into the openings of the diameter.

The liner 2 may be formed of any known material as long as the material is capable of holding the housed in the space inside the liner 2 without any leakage. In this example, the liner 2 is formed of a resin such as nylon resins and polyethylene synthetic resins.

The thickness of the liner 2 is not particularly limited, but is preferably approximately 0.5 mm to 3.0 mm in view of reducing the weight.

<Mouthpieces>

The mouthpieces 3 are metal members that are arranged at the opening end parts of the liner 2. The mouthpieces 3 are used as chuck parts when the tank 1 is manufactured, and form ports when the tank 1 is filled with the housed and when the housed is taken out of the tank 1. The structure of such mouthpieces may be any known one.

<Stiffener Layer>

The stiffener layer 4 has a fiber layer, and a resin that is impregnated with the fiber layer and cured. The fiber layer is formed by winding many layers of bundles of fiber around the outer surface of the liner 2 by a predetermined thickness.

A carbon fiber is used for the bundles of fiber of the fiber layer. The bundles of fiber are bundles of a carbon fiber in the form of a belt having a predetermined cross-sectional shape (e.g., rectangular cross section). This cross-sectional shape is not particularly limited, but may be a rectangle of approximately 6 mm to 9 mm in width and 0.1 mm to 0.15 mm in thickness. The amount of a carbon fiber contained in the bundles of fiber is not particularly limited either. For example, the bundles of fiber are formed of approximately 36000 strands of a carbon fiber.

Such bundles of fiber formed of a carbon fiber are wound around the outer surface of the liner 2, to form the fiber layer.

The resin impregnated with the fiber layer and cured in the stiffener layer 4 is not particularly limited as long as permeating the fiber layer with fluidity first and thereafter curing by some method to make it possible to increase the strength of the fiber layer. Examples of the resin include thermosetting resins that cure by heat, such as epoxy resins and unsaturated polyester resins each including an amine or anhydride-based curing accelerator and a rubber-based reinforcing agent. Examples of the resin also include resin compositions containing an epoxy resin as a main agent: a curing agent is mixed to the resin composition to cure the resin composition. According to this, a main agent and a curing agent are mixed, thereafter a resin composition that is a mixture of the main agent and the curing agent is allowed to permeate the fiber layer before curing, which results in the resin composition automatically curing.

<Others>

In addition to the foregoing, a protective layer may be disposed for the tank if necessary. The protective layer is a layer that is arranged on the outer circumference of the stiffener layer, and is formed by winding a glass fiber and impregnating the glass fiber with a resin. The resin with which the glass fiber is impregnated may be considered same as in the stiffener layer. This gives the high-pressure tank impact resistance. The thickness of the protective layer is not particularly limited, but may be approximately 1.0 mm to 1.5 mm.

2. Tank Holders

As can be seen from FIGS. 1 to 4, the tank holders 10 according to this embodiment each have a first holding member 11 and a second holding member 21. The tank 1 is sandwiched between the first holding member 11 and the second holding member 21 around the outer circumferential portion thereof: the end portions of the first holding member 11 and the second holding member 21 are coupled to each other via coupling members 30, so that the tank holders 10 are arranged so as to surround the outer circumference of the tank 1.

The first holding member 11 is formed to have stiffener plates 12 and a band 13. The second holding member 21 is formed to have stiffener plates 22 and a band 23. Hereinafter the structure of each of them will be described.

2.1. Stiffener Plates

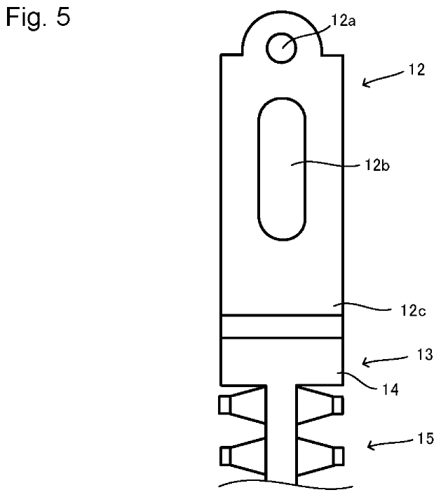

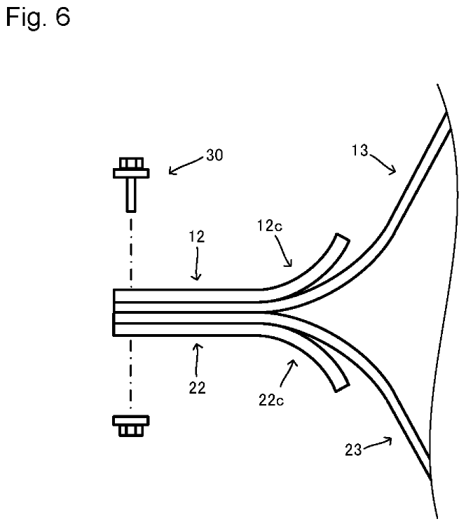

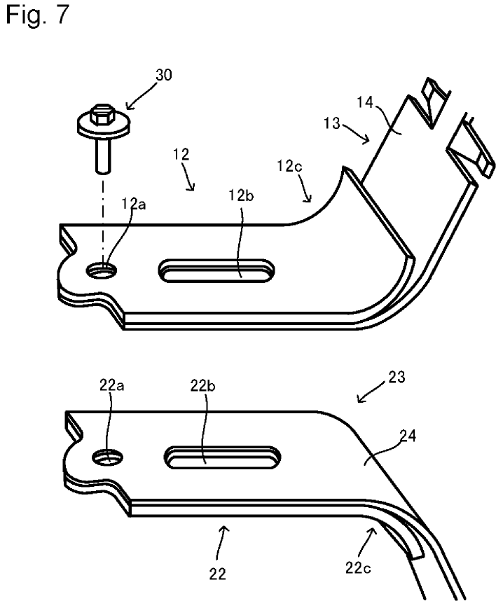

The stiffener plates 12 are boardlike members that are arranged at both ends of the belt-like band 13 respectively. The stiffener plates 22 are boardlike members that are arranged at both ends of the belt-like band 23 respectively. FIGS. 5 to 7 illustratively show one of the stiffener plates 12. FIG. 5 is an enlarged view of the portion indicated by C in FIG. 1. It is noted that a coupling member 30 and the tank 1 are not shown. FIG. 6 is an enlarged view of the portion indicated by D in FIG. 3. It is noted that the coupling member 30 is separately shown. FIG. 7 is an exploded perspective view focused on the portions of the stiffener plates 12 and 22.

Here, in this embodiment, the stiffener plate 12 and the stiffener plate 22 are formed to have the same shape. Therefore, here, the stiffener plate 12 will be described and the description of the stiffener plate 22 will be omitted. The stiffener plate 22 may be also considered same.

As for the tank holders 10, “length direction” means a longitudinal direction of the belt-like bands 13 and 23, “width direction” means a width direction of the belt-like bands 13 and 23, and “thickness direction” means a direction orthogonal to the length direction and the width direction.

In this embodiment, the stiffener plate 12 is arranged so as to be superimposed on one face of the band 13 (band 23 in the stiffener plate 22) at an end portion of the band 13. The size of the stiffener plate 12 in the width direction is approximately the same as that of the band 13 at the portion where the stiffener plate 12 is arranged.

The size of the stiffener plate 12 in the length direction is preferably such that the stiffener plate 12 encompasses a portion where one face of the band 13 and one face of the band 23 are superimposed as the tank 1 is held. This makes it possible to stably fix the tank 1. The stiffener plate 12 may extend over the portion where the band 13 and the band 23 are superimposed to reach a position where the band 13 and the band 23 are separated. This makes it possible to further stably hold the tank 1. At this time, a portion of the stiffener plate 12 which is located at the position where the band 13 and the band 23 are separated preferably has a curved portion 12c that is curved in the thickness direction (curved portion 22c in the stiffener plate 22). As can be seen from FIGS. 6 and 7, this curved portion 12c is formed so as to be capable of suppressing an edge of the stiffener plate 12 in hard contact with the band 13. Therefore, the edge of the curved portion 12c of the stiffener plate 12 is preferably curved so as not to be in contact with the band 13 as the tank 1 is held. This suppresses the edge of the stiffener plate 12 damaging the band 13.

A hole 12a penetrating in the thickness direction (hole 22a in the stiffener plate 22) is disposed at an end portion of the stiffener plate 12 in the length direction which faces the end portion of the band 13. The coupling member 30 is passed through the hole 12a, so that the stiffener plate 12 is fixed to the stiffener plate 22 of the second holding member 21.

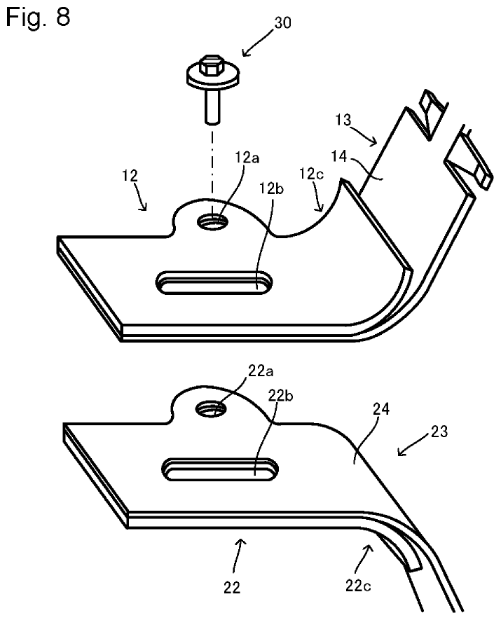

In this example, the hole 12a is disposed at the end portion of the stiffener plate 12 in the length direction. The present disclosure is not limited to this. The hole 12a may be disposed at another portion. FIG. 8 shows an example. In the example of FIG. 8, the hole 12a is disposed on one end side of the stiffener plate 12 in the width direction. For example, when a space for holding the tank 1 cannot be effectively used if the hole 12a were at the end portion of the stiffener plate 12 in the length direction, the hole 12a (hole 22a) may be as in FIG. 8 instead of that as in FIGS. 1 to 7. This hole 12a as in FIG. 8 is also a hole through which the coupling member 30 is passed.

The stiffener plate 12 has a long hole 12b that extends long in the length direction and penetrates in the thickness direction (long hole 22b in the stiffener plate 22). As described later, a fixing member 6 is passed through these long holes 12b and 22b, which results in the tank 1 where the tank holders 10 are arranged fixed to, for example, equipment of a vehicle etc.

The tank 1 where the tank holders 10 are arranged fixed to the equipment with the fixing member 6 passed through the long holes 12b and 22b makes it possible to absorb movement of the stiffener plate 12 and the stiffener plate 22 in the longitudinal direction following expansion and contraction of the tank 1. The operation of the tank holders 10 following expansion and contraction of the tank 1 will be described later.

The stiffener plate 12 and the stiffener plate 22 are members for coupling the first holding member 11 and the second holding member 21 to each other, to further fix the first holding member 11 and the second holding member 21 to the equipment with the fixing member 6. The stiffener plate 12 and the stiffener plate 22 are preferably a metal since a material having high strength even if being thin is desirable in view of avoiding occupation of a large space. Examples of the metal include stainless steel having a thickness of approximately 1 mm to 3 mm.

The stiffener plate 12 and the band 13 may be optionally joined to each other, but are preferably joined in view of obtaining more robust and stable tank holders. The joining method is not particularly limited, but may be joining with an adhesive, welding or the like.

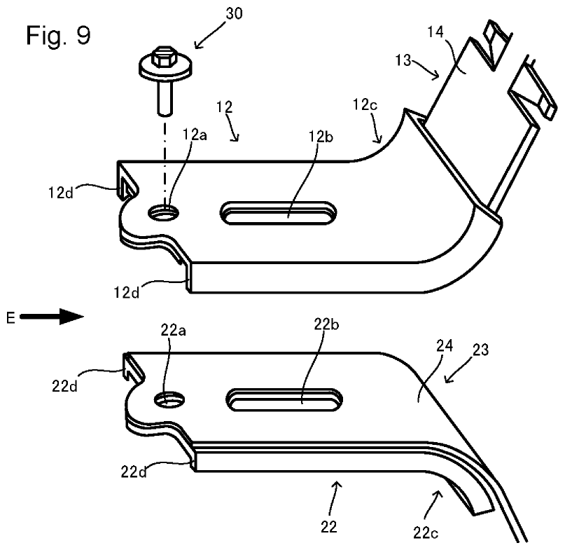

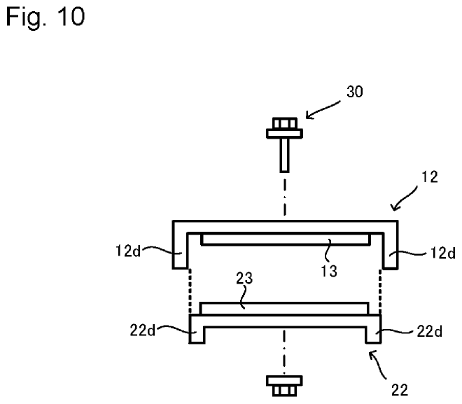

The stiffener plate 12 and the stiffener plate 22, which have been described so far, have the same shape. This makes it possible to reduce kinds of components. The present disclosure is not limited to the foregoing however. The stiffener plate 12 and the stiffener plate 22 may have different shapes. FIGS. 9 and 10 show an example of different shapes of the stiffener plate 12 and the stiffener plate 22. FIG. 9 is an exploded perspective view, and FIG. 10 shows FIG. 9 viewed in the direction indicated by the arrow E.

As can be seen from these figures, in the example of FIGS. 9 and 10, sides 12d rising toward the stiffener plate 22 from edges of the stiffener plate 12 in the width direction, and sides 22d rising in the direction opposite to the stiffener plate 12 side from edges of the stiffener plate 22 in the width direction are included.

Further, as can be seen well from FIG. 10, in this example, the size between the two sides 12d of the stiffener plate 12 is formed to be larger than that of the stiffener plate 22 in the width direction. This makes it possible to house the stiffener plate 22 between the sides 12d of the stiffener plate 12 when the stiffener plate 12 and the stiffener plate 22 are superimposed to be coupled via the coupling member 30. Therefore, the sides 12d and the sides 22d are capable of increasing the rigidity of the stiffener plates, and make it possible to superimpose the two stiffener plates compactly.

2.2. Band

### <Form of Band 1>

The band 13 and the band 23 are belt-like members. As can be seen from FIGS. 1 to 4, the band 13 and the band 23 are arranged so as to be along the outer circumference of the tank 1 as the tank 1 is sandwiched therebetween as the tank holders 10 hold the tank 1. More specifically, the faces of the band 13 and the band 23 on one side which are formed by the length direction and the width direction of the band 13 and the band 23 are arranged so as to face the outer circumference of the tank 1, and the thickness direction of the band 13 and the band 23 is the diameter direction of the tank.

In the present disclosure, the band 13 and the band 23 each have a structure capable of generating pressing force in the thickness direction thereof. This makes it possible to generate pressing force in the diameter direction of the tank 1 to maintain a state where the band 13 and the band 23 are in close contact with the outer circumference of the tank 1.

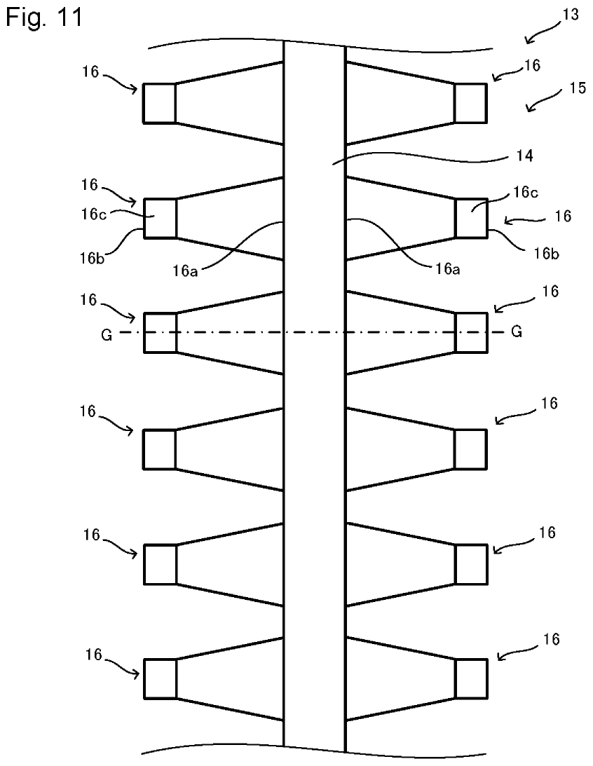

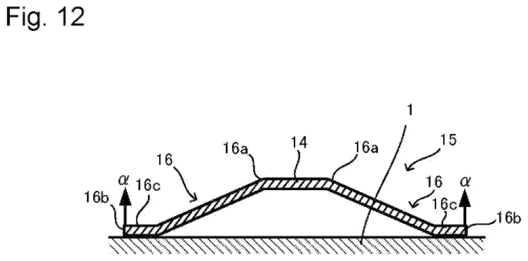

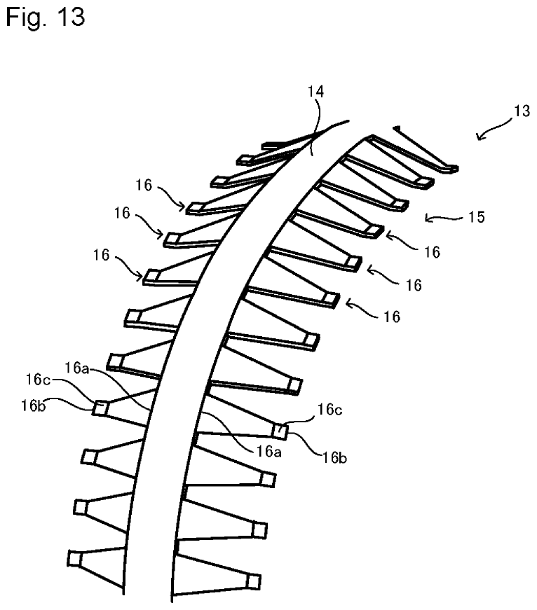

FIGS. 11 and 12 show the structure of the band 13 included in each of the tank holders 10 according to the present embodiment. FIG. 11 is an enlarged view of the portion indicated by F in FIG. 1, and FIG. 12 shows a cross section taken along the line G-G in FIG. 11. FIG. 13 is a perspective view partially showing the band 13.

Here, in this embodiment, the band 13 and the band 23 are formed to have the same shape. Therefore, here, the band 13 will be described and the description of the band 23 will be omitted. The band 23 may be also considered same.

The band 13 according to this embodiment has a base part 14 and a pressing part 15 (base part 24 and pressing part 25 in the band 23).

The base part 14 is a part that is the base of the band 13, and is in the form of a belt as a whole. The base part 14 of the band 13 according to the present embodiment is formed to be larger at portions superimposed on the stiffener plates 12 and to be smaller in any other portion that is most thereof, in the width direction. Pressing elements 16 are provided with this other portion to form the pressing part 15.

Holes and long holes are disposed at positions corresponding to the holes 12a and the long holes 12b of the stiffener plates 12 on the portions of the base part 14 which are superimposed on the stiffener plates 12. These holes and long holes are formed to penetrate the stiffener plates 12 and the band 13 in the thickness direction.

The pressing part 15 is a portion where a plurality of the pressing elements 16 are arranged. In this embodiment, the pressing part 15 is disposed at the portion of the base part 14, which is smaller in the width direction, and is formed of the pressing elements 16 arranged on each side of the base part 14 in the width direction. That is, in this embodiment, two columns of the pressing elements 16, which align in the length direction of the base part 14, are arranged across the base part 14 in the width direction.

Each of the pressing elements 16 extends in the width direction from a root part 16a that is coupled to the base part 14, and a tip part 16b thereof is a free end. As shown in FIG. 12, each of the pressing elements 16 extends in the width direction, and inclines so as to approach the tank 1 as separating the base part 14, which results in the tip part 16b protruding in the thickness direction. The band 13 then has a form such that the tip parts 16b of the pressing elements 16 are in contact with the outer circumference of the tank 1 and the base part 14 floats above the outer circumference of the tank 1 when the band 13 is arranged around the outer circumference of the tank 1. The pressing elements 16 receive pressing force from the tank 1, which deforms the tip parts 16b of the pressing elements 16 in the directions indicated by the arrows α in FIG. 12. The pressing elements 16 generate biasing force against this, to press the tank 1. This allows a state where the band 13 is in close contact with the tank 1 to be maintained. This pressing force changes according to a degree of elastic deformation of the pressing elements 16 due to expansion and contraction of the tank 1. In any case, the shapes of the pressing elements 16 are preferably determined so that the tank can be held within the extent of the elastic deformation.

In the present embodiment, each of the pressing elements 16 has a shape such as to be thinner toward the tip part 16b from the root part 16a viewed as FIG. 11. This can improve equalization of stress generated in any portions when the pressing elements 16 are displaced. That is, a pressing element having a width narrowing from the root part toward the tip part equalizes the distribution of stress when deforming, which lowers the maximum stress when the tip part is displaced to some extent. This makes it possible to shorten the pressing element, to design a small area of the materials, and to reduce the weight.

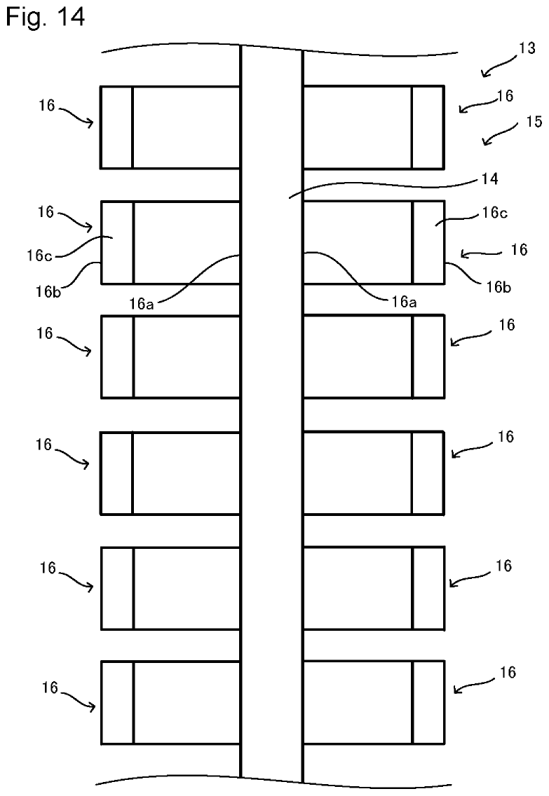

When the width of each of the pressing elements 16 is fixed but not narrowed toward the tip part from the root part, bending stress of the root part tends to be greater. Since the stress at a portion near the tip part which is in contact with the tank is weaker, the difference (magnification) between the bending stress and the stress near the tip part may be larger. As a result, the pressing elements must be longer in order that such a design is produced that the stress concentrated on the root parts does not exceed the yield stress of the plate materials when the pressing elements are displaced to some extent (displaced according to the change in the tank diameter), which leads to a tendency to enlarge the area of the materials to be used. It is not necessary to limit the shape of the pressing element to a tapered shape as long as such a matter is not problematic. As shown in FIG. 14, the shape may be such as not to narrower from the root part 16a toward the tip part 16b. FIG. 14 corresponds to FIG. 11.

In the present embodiment, the inclination angle changes at the tip part 16b of each of the pressing elements 16, so that the pressing element 16 has a claw part 16c that is a bent part. This bending may be such as to be parallel to the surface of the tank when the pressing element is largely displaced in response to high pressure from the tank. This makes it possible to secure a large contact area between the pressing elements 16 and the tank 1 especially when the pressing elements 16 receive high pressure from the tank 1. This large contact area can also suppress damage to the surface of the tank 1 due to the edges of the pressing elements 16.

The claw parts 16e are not always necessary. For example, when not only the tip parts but also most or all of the portion between the tip parts and the root parts are in contact with the tank when the pressing elements receive force from the tank, the claw parts are not necessarily disposed. In view of this, it can be said that the effect of the claw parts is remarkable when the pressing elements are rigid so as to be difficult to deform because such pressing elements tend to be in contact with the tank only at the tip parts.

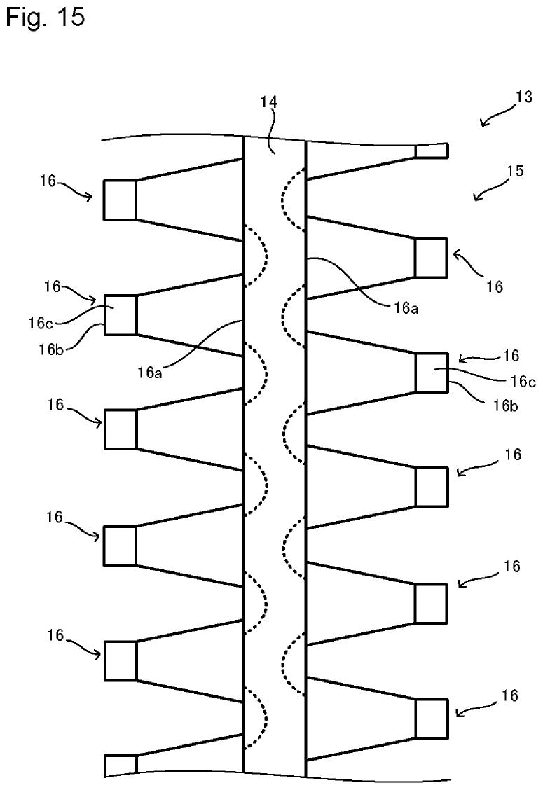

In the present embodiment, the pressing elements 16 are arranged at the same position on both sides of the base part 14 in the width direction. The present disclosure is not limited to this. As shown in FIG. 15, the pressing elements 16 are aligned so that each pitch in the length direction is shifted by half on both sides of the base part 14 in the width direction, so as not to be at the same position. FIG. 15 corresponds to FIG. 11.

According to this example, when the pressing elements 16 press the tank 1, greater stress is generated on the portions at the connection portions of the root parts 16a of the pressing elements 16 and the base part 14 which are surrounded by dotted lines than on the other portion. According to the example of FIG. 15, the pressing elements 16 are arranged so as to be shifted by a half pitch as described above, which makes it possible not to superimpose the positions where the stress is greater. This is useful in view of securing high strength.

The material for forming such a band is not particularly limited. In the present disclosure, the material is preferably advantageous in strength and elastic deformation in view of forming the band so that the band includes the pressing elements to also function as a plate spring. In such a view, the material is preferably a metal, and examples thereof include stainless steel. Also, the material, thickness, and shape of the pressing elements may be changed in order to obtain proper elasticity. The thickness is not limited, but in the case of stainless steel, can be approximately 0.5 mm to 2 mm.

<Form of Band 2>

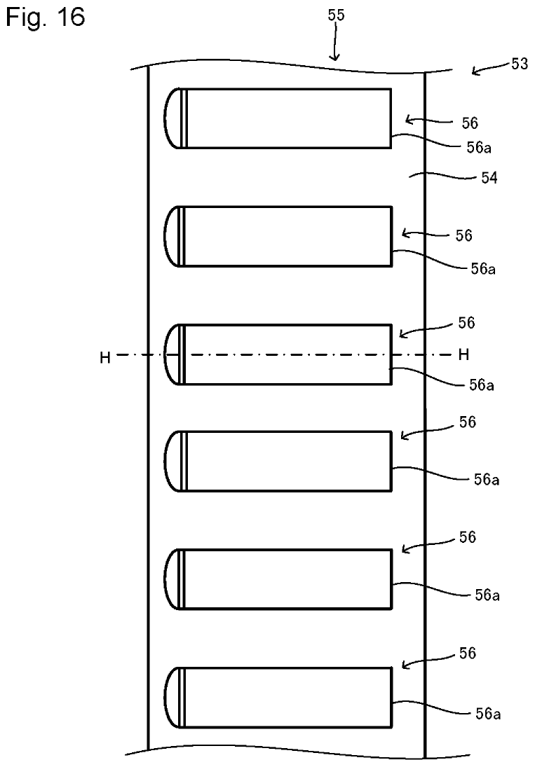

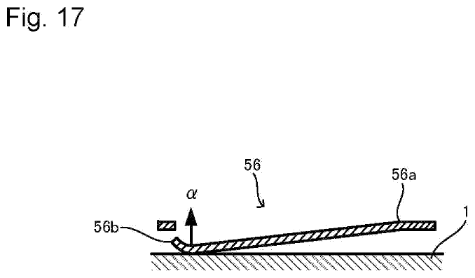

FIGS. 16 and 17 illustratively show the form of a band 53 which is different from the band 13. FIG. 16 corresponds to FIG. 11, and FIG. 17 shows a cross section taken along the line indicated by H-H in FIG. 16.

On the band 53, a plurality of pressing elements 56 are aligned inside a belt-like base part 54 in the length direction, to form a pressing part 55.

Each of the pressing elements 56 is coupled to the base part 54 as one end side thereof in the width direction of the base part 54 is used as a root part 56a, and extends toward the other end side in the width direction of the base part 54. A tip part 56b is a free end. As shown in FIG. 17, each of the pressing elements 56 extends in the width direction, and inclines so as to approach the tank 1 as separating the root part 56a, which results in the tip part 56b protruding in the thickness direction. The band 53 then has a form such that the tip parts 56b side of the pressing elements 56 is in contact with the outer circumference of the tank 1 and the base part 54 floats above the outer circumference of the tank 1 when the band 53 is arranged around the outer circumference of the tank 1. The pressing elements 56 receive pressing force from the tank 1, which deforms the tip parts 56b of the pressing elements 56 in the directions indicated by the arrow a in FIG. 17. The pressing elements 56 generate biasing force against this, to press the tank 1. This allows a state where the band 53 is in close contact with the tank 1 to be maintained. This pressing force changes according to a degree of elastic deformation of the pressing elements 56 due to expansion and contraction of the tank 1. In any case, the shapes of the pressing elements 56 are preferably determined so that the tank can be held within the extent of the elastic deformation.

The tip part 56b of each of the pressing elements 56 in the present embodiment also bends towards the base part 54 side, so that the pressing element 56 has a claw part 56c. This suppresses generation of high pressure and damage to the tank 1 due to the contact with the tank 1.

The same effect is brought about even if such a band 53 is used instead of the band 13 and the band 23.

<Form of Band 3>

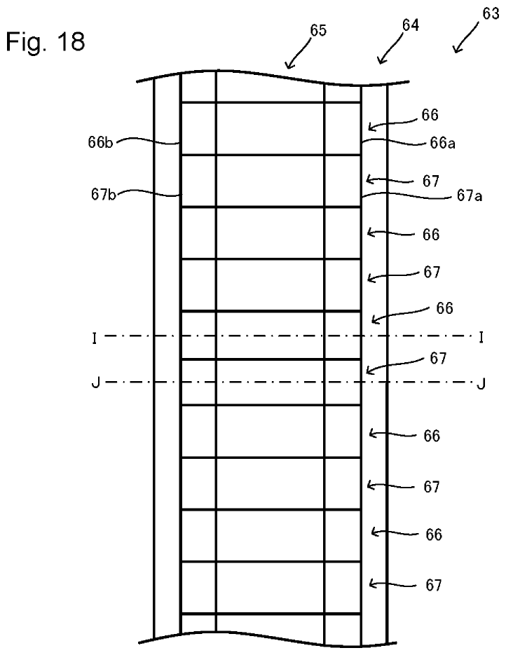

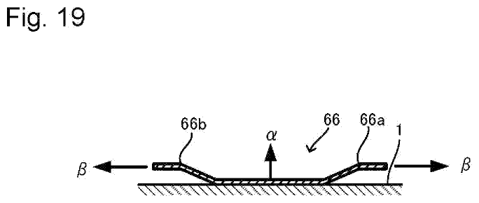

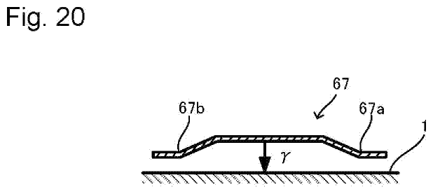

FIGS. 18 to 20 illustratively show the form of a band 63 which is different from the foregoing bands. FIG. 18 corresponds to FIG. 11, FIG. 19 shows a cross section taken along the line indicated by I-I in FIG. 18, and FIG. 20 shows a cross section taken along the line indicated by J-J in FIG. 18.

On the band 63, first pressing elements 66 and second pressing elements 67 that are two types of pressing elements are alternately aligned inside a belt-like base part 64 in the length direction, to form a pressing part 65.

Each of the first pressing elements 66 is coupled to the base part 64 as one end side thereof in the width direction of the base part 64 is used as a root part 66a and the other end side in the width direction of the base part 64 is used as a root part 66b. A member arranged between these two root parts, which are the root part 66a and the root part 66b, is bent so as to protrude in the thickness direction (direction approaching the tank 1). More specifically, as shown in FIG. 19, each of the first pressing elements 66 inclines and extends in directions approaching each other from the root part 66a and the root part 66b respectively and also approaching the tank 1. The first pressing element 66 reaches predetermined positions in the thickness direction, to extend so as to be parallel to the width direction. In this embodiment, the first pressing elements 66 are arranged so that portions thereof extending in parallel to the width direction are in contact with the tank 1.

Each of the second pressing elements 67 is coupled to the base part 64 as one end side thereof in the width direction of the base part 64 is used as a root part 67a and the other end side in the width direction of the base part 64 is used as a root part 67b. A member arranged between these two root parts, which are the root part 67a and the root part 67b, is bent so as to protrude in the thickness direction (direction separating the tank 1 and opposite to the first pressing elements 66 in the thickness direction). More specifically, as shown in FIG. 20, each of the second pressing elements 67 extends in oblique directions approaching each other from the root part 67a and the root part 67b respectively and also separating the tank 1. The second pressing element 67 reaches predetermined positions in the thickness direction, to extend so as to be parallel to the width direction. In this embodiment, the second pressing elements 67 are arranged at positions separating the tank 1.

In this embodiment, the first pressing elements 66 are in contact with the outer circumference of the tank 1, and the base part 64 floats above the outer circumference of the tank 1. When receiving force from the tank 1, the first pressing elements 66 are deformed as indicated by the arrow a in FIG. 19. Since both ends of each of the first pressing elements 66 in the width direction are coupled to the base part 64, the base part 64 deforms so as to spread in the width direction as indicated by the arrows β in FIG. 19. This leads to deformation of the second pressing elements 67 as indicated by the arrow γ in FIG. 20, and the pressing part 65 as a whole generates biasing force against this deformation. The tank 1 is pressed by this biasing force, which allows a close contact state with the tank 1 to be maintained.

In the present embodiment, the first pressing elements 66 and the second pressing elements 67 are alternately aligned in the length direction. The present disclosure is not limited to this. For example, the first pressing elements 66 and the second pressing elements 67 in necessary proportion may be arranged in order to obtain required elastic force.

The same effect is brought about even if such a band 63 is used instead of the band 13 and the band 23.

<Form of Band 4>

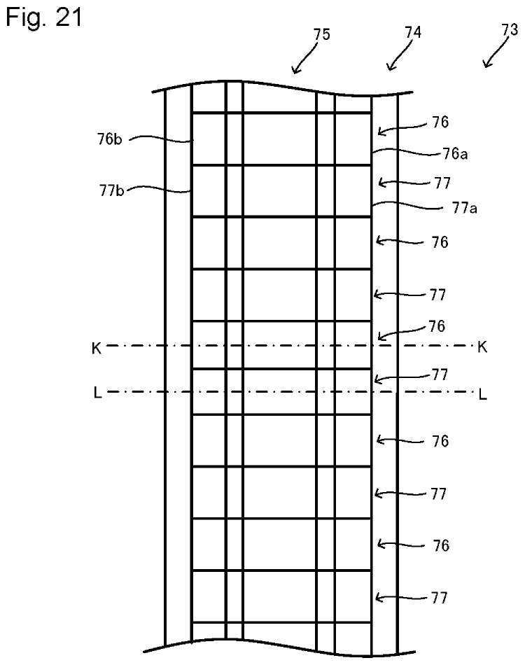

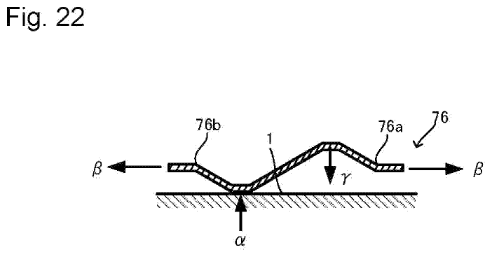

FIGS. 21 to 23 illustratively show the form of a band 73 which is different from the foregoing bands. FIG. 21 corresponds to FIG. 11, FIG. 22 shows a cross section taken along the line indicated by K-K in FIG. 21, and FIG. 22 shows a cross section taken along the line indicated by L-L in FIG. 21.

On the band 73, first pressing elements 76 and second pressing elements 77 that are two types of pressing elements are alternately aligned inside a belt-like base part 74 in the length direction, to form a pressing part 75.

Each of the first pressing elements 76 is coupled to the base part 74 as one end side in the width direction of the base part 74 is used as a root part 76a and the other end side thereof in the width direction of the base part 74 is used as a root part 76b. A member arranged between these two root parts, which are the root part 76a and the root part 76b, is bent so as to protrude in the thickness direction. More specifically, as shown in FIG. 22, each of the first pressing elements 76 has a portion inclining in a direction separating the tank 1 as separating the root part 76a, and a portion that is parallel to the width direction which starts from a location where the inclining portion reaches a predetermined position in the thickness direction. Each of the first pressing elements 76 further has a portion inclining in a direction approaching the tank 1 as separating the root part 76a, and a portion that is parallel to the width direction which starts from a location where the inclining portion reaches a predetermined position in the thickness direction. Each of the first pressing elements 76 also has a portion inclining in a direction separating the tank 1 toward the root part 76b to reach the root part 76b.

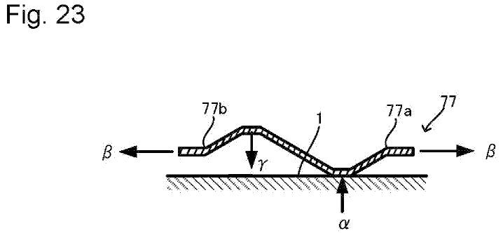

Each of the second pressing elements 77 is coupled to the base part 74 as one end side thereof in the width direction of the base part 74 is used as a root part 77a and the other end side in the width direction of the base part 74 is used as a root part 77b. A member arranged between these two root parts, which are the root part 77a and the root part 77b, is bent so as to protrude in the thickness direction. More specifically, as shown in FIG. 23, each of the second pressing elements 77 has a portion inclining in a direction approaching the tank 1 as separating the root part 77a, and a portion that is parallel to the width direction which starts from a location where the inclining portion reaches a predetermined position in the thickness direction. Each of the second pressing elements 77 further has a portion inclining in a direction separating the tank 1 as separating the root part 77a, and a portion that is parallel to the width direction which starts from a location where the inclining portion reaches a predetermined position in the thickness direction. Each of the second pressing elements 77 also has a portion inclining in a direction approaching the tank 1 toward the root part 77b to reach the root part 77b.

In this embodiment, the first pressing elements 76 and the second pressing elements 77 are in contact with the outer circumference of the tank 1 at different positions in the width direction, and the base part 74 floats above the outer circumference of the tank 1. When receiving force from the tank 1, the first pressing elements 76 and the second pressing elements 77 deform in the directions indicated by the arrows α in FIGS. 22 and 23 at portions thereof in contact with the tank 1. Since both ends of each of the first pressing elements 76 and the second pressing elements 77 in the width direction are coupled to the base part 74, the first pressing elements 76 and the second pressing elements 77 deform so that the base part 74 spreads in the width direction as the arrows β in FIGS. 22 and 23. This leads to deformation of portions of the first pressing elements 76 and the second pressing elements 77 which protrude on the opposite side to the tank 1, in the direction indicated by the arrows γ in FIGS. 22 and 23. The pressing part 75 as a whole generates biasing force against this deformation. The tank 1 is pressed by this biasing force, which allows a close contact state with the tank 1 to be maintained.

The same effect is brought about even if such a band 73 is used instead of the band 13 and the band 23.

2.3. Coupling Member

The coupling members 30 are members that couple the stiffener plates 12 of the first holding members 11 and the stiffener plates 22 of the second holding members 21. Each of the coupling members 30 may be the combination of a bolt and a nut as shown in FIGS. 1 to 10. At this time, the nut may be fixed to the stiffener plate in advance by welding or the like, or may be a separate member.

2.4. Cover

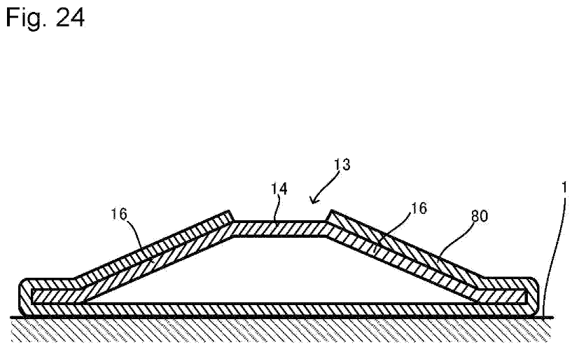

The pressing part of the band included in any form may be covered with a cover, which is illustratively shown in FIG. 24. FIG. 24 corresponds to FIG. 12 in an example where a cover 80 is arranged on the band 13. As can be seen from FIG. 24, part of the band 13 which at least encompasses the portion in contact with the tank 1 is covered with the cover 80. Here, the band 13 is used as an example. The cover may be also disposed in any other foregoing forms.

Such a cover may be made from a resin or rubber. Coating the band with a cover made from a resin or rubber makes it possible to avoid the band made from a metal from being in direct contact with the tank, to suppress damage to the tank.

2.5. Combination of First Holding Member and Second Holding Member

The above described first holding members 11 and second holding members 21 are arranged on the tank 1 and combined, which is more specifically as follows. Here, description will be given with the example of having the band 13 and the band 23 with reference to FIGS. 1 to 4. The same is applied to any other foregoing examples of having other bands.

The first holding members 11 and the second holding members 21 are arranged along the outer circumference of the tank 1 as shown in FIGS. 1 to 4. At this time, the band 13 and the band 23 are arranged so that faces thereof which are formed to be capable of exerting pressing force, i.e., faces on a side where the pressing elements 16 and the pressing elements 26 (pressing elements of the second holding members 21) protrude are in contact with the surface of the tank 1.

Next, as also shown in FIGS. 6 to 10, one of the stiffener plates 12, the end portion of the band 13, the end portion of the band 23, and one of the stiffener plates 22 are fixed with the coupling member 30 that is passing through the hole 12a and the hole 22a at a portion where the stiffener plate 12, the end portion of the band 13, the end portion of the band 23, and the stiffener plate 22 are superimposed in that order. In this way, the tank holders 10 are arranged around the outer circumferential portion of the tank 1.

3. Fixing of Tank where Tank Holders are Arranged to Equipment

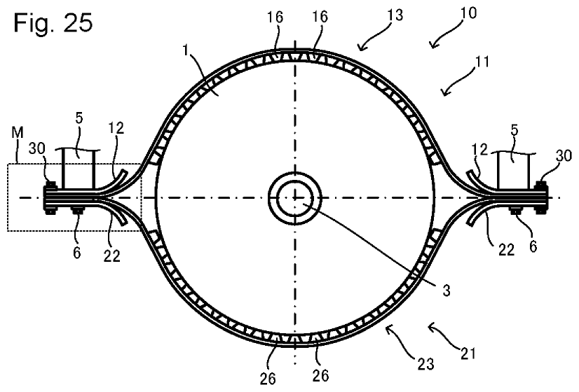

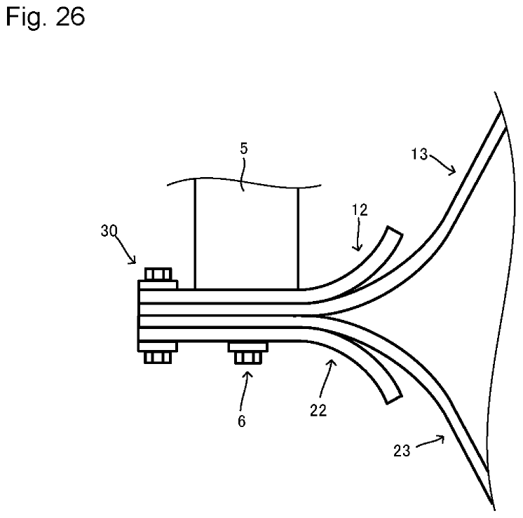

As described above, the tank 1 where the tank holders 10 are arranged is fixed to, for example, equipment of a vehicle etc., which is illustratively shown in FIGS. 25 and 26. FIG. 25 shows a scene where the tank 1 is fixed to equipment, viewed in the same manner as FIG. 3, and FIG. 26 is an enlarged view of the portion indicated by M in FIG. 25.

As can be seen from these figures, the fixing members 6 that are formed of bolts pass through the long holes 12b and the long holes 22b (see FIG. 7), to fix the tank 1 where the tank holders 10 are arranged to fixing parts 5 of the equipment.

This results in the tank 1 fixed to the equipment via the tank holders 10.

4. Effect and so on

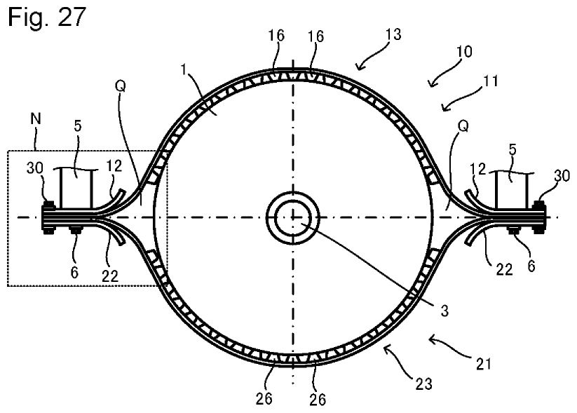

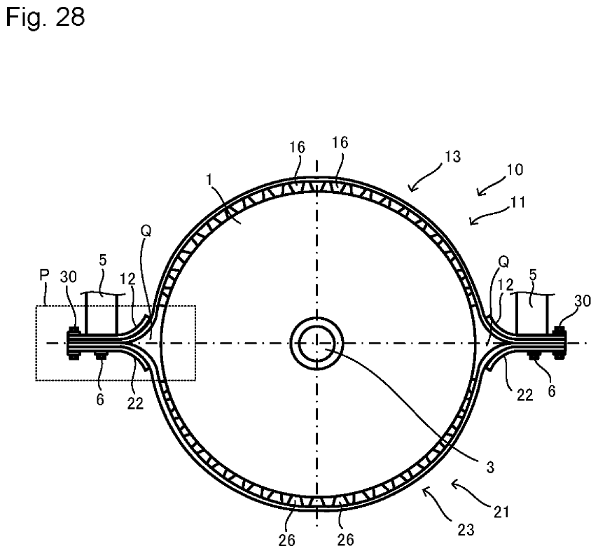

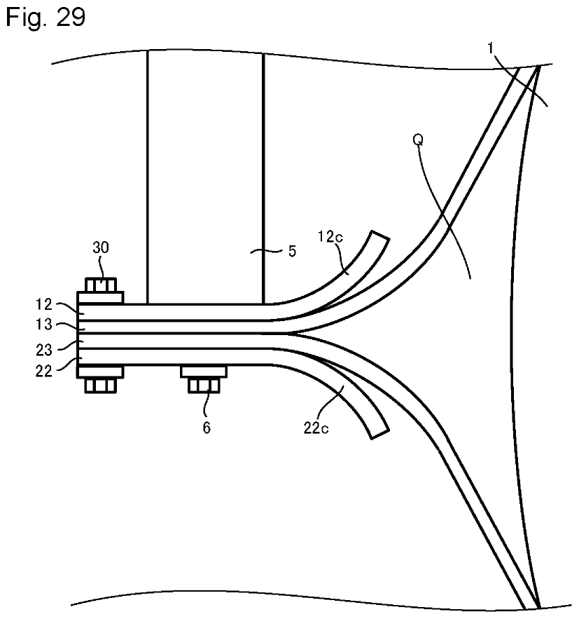

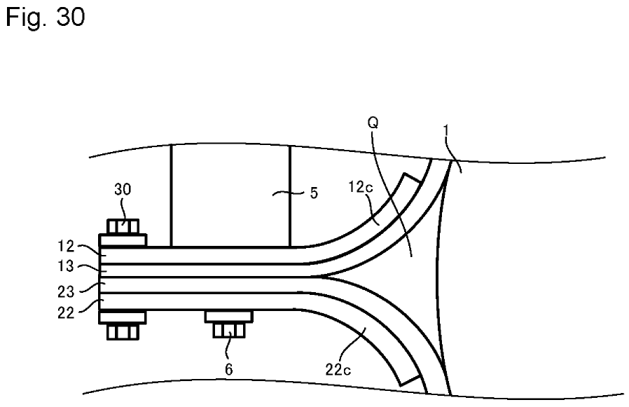

The tank holders 10 of the present disclosure operate as follows, which is illustratively shown in FIGS. 27 and 28. FIG. 27 is viewed in the same manner as FIG. 25, and shows a case where the diameter of the tank 1 is smaller, or a state before expansion. FIG. 28 shows a case where the diameter of the tank 1 is larger, or a state in expansion. FIG. 29 is an enlarged view of the portion indicated by N in FIG. 27, and FIG. 30 is an enlarged view of the portion indicated by P in FIG. 28.

As can be also seen from these figures, when the diameter of the tank 1 is smaller or before the tank 1 expands, spaces Q between the stiffener plates 12, the stiffener plates 22 and the tank 1 are formed larger. Thus, the bands 13 and the bands 23 stably hold the tank 1 as applying pressing force via the pressing elements 16 of the pressing portions 15 and the pressing elements 26 of the pressing portions 25. When the diameter of the tank 1 is larger or the tank 1 is, for example, filled with the content to expand, the spaces Q between the stiffener plates 12, the stiffener plates 22 and the tank 1 become smaller. The bands 13 and the bands 23 further stably hold the tank 1 as pressing force is greater due to large deformation of the pressing elements 16 of the pressing portions 15 and the pressing elements 26 of the pressing portions 25.

As described above, the tank holders of the present disclosure are capable of absorbing change in the diameter of the tank owing to deformation of the pressing elements disposed on the bands, and change in the size of the spaces Q due to the deformation of the bands. Therefore, it is not necessary to dispose any coil spring as the conventional. A space can be effectively used instead.

In view of effectively using a space owing to unnecessity of disposing of a coil spring as described above, at least one kind of members out of the first holding members and second holding members has only to be included.

Arrangement of both the first holding members and the second holding members, i.e., arrangement of the pressing elements all around the circumference of the tank makes it possible to suppress the movement of the circumferential portion of the tank in one direction by the extent exceeding the change due to expansion and contraction of the tank since there is almost no change in the center position of the tank even if the diameter of the tank changes following the expansion and the contraction. That is, a space can be effectively used in view of the foregoing as well.

A valve of a tank is usually fastened to a mouthpiece of the tank. According to the present disclosure, the position of the central axis of the tank does not move up and down regardless of enlargement and reduction of the diameter of the tank, which makes it hard for the position of the mouthpiece to shift, so that no static strain is given to a pipe fastened to the valve. This makes it possible to suppress cracks occurring in a pipe which frequently occur due to addition of dynamic strain because of vehicle's running.

Using at least one kind of members out of the first holding members and the second holding members causes the entire bands to absorb change according to expansion and contraction of the tank, which makes it possible to equalize the force of the bands holding the tank compared to the case of using a means arranged too far to one side as a conventional coil spring, which makes it possible to reduce the load on the tank.

As can be seen from FIG. 1 etc., the pressing elements in the foregoing examples each have a shape extending in the width direction. That is, according to this arrangement, the pressing elements extend in an direction extending in parallel to the axis of the tank. This makes it possible to reduce friction between the pressing elements and the surface of the tank even if the surface of the tank moves in the axial direction when the tank expands and contracts, which can suppress the pressing elements caught by the tank, and occurrence of abnormal noise.

Regarding the stiffener plates, the tank provided with the tank holders is fixed to equipment with the fixing members via the long holes of the stiffener plates, which makes it possible to absorb any difference in the diameter of the tank even if there is any change or difference in the diameter of the tank, to fix the tank to the equipment, and to maintain this fixing.

As can be seen from the comparison of FIGS. 29 and 30, the curved portion 12c of each of the stiffener plates 12 is formed to have a gap between itself and the band 13, and the curved portion 22c of each of the stiffener plates 22 is formed to have a gap between itself and the band 23 when the diameter of the tank is smaller (FIG. 29), which can suppress the force of contact even if the band 13 is in contact with the curved portion 12c and even if the band 23 is in contact with the curved portion 22c when the diameter of the tank is larger (FIG. 30), which can suppress damage to the band 13 and the band 23 by the edges of the stiffener plate 12 and the stiffener plate 22.

### REFERENCE SIGNS LIST

1 high-pressure tank
10 tank holder
11 first holding member
12 stiffener plate
13 band
16 pressing element
21 second holding member
22 stiffener plate
23 band

What is claimed is:

1. A tank holder to hold a tank, the tank holder comprising:
a belt-shaped band that is arranged along an outer circumference of the tank, the band being provided with a plurality of pressing elements that protrude to press a surface of the tank and elastically deform.

2. The tank holder according to claim 1, wherein
the number of the bands is two, the outer circumference of the tank is sandwiched between the two bands, and each end portions of the two bands are coupled to each other.

3. The tank holder according to claim 1, wherein
a stiffener plate is arranged at each of the end portions of the bands, and a long hole extending in a length direction of the bands is provided with the stiffener plate.

4. The tank holder according to claim 1, wherein
the pressing elements are like boards and are coupled to the bands via both ends thereof.

5. The tank holder according to claim 1, wherein one end of each of the pressing elements is a free end.

6. The tank holder according to claim 1, wherein the pressing elements is coated with a cover.
